(19) United States
(12) Patent Application Publication
(10) Pub. No.: US 2025/0353335 A1
(43) Pub. Date: Nov. 20, 2025

(54) System for Disassembling Tire-Wheel Assemblies and Related Methods

(71) Applicant: Android Industries LLC, Auburn Hills, MI (US)

(72) Inventors: Joshua James Hicks, Grand Blanc, MI (US); Anthony B. Cassisi, Dryden, MI (US); Kerry Verran, Davison, MI (US); Anthony W. Pierce, Owosso, MI (US); Christopher M. Bulliner, Flushing, MI (US); John E. Donnay, West Bloomfield, MI (US); Andrew Schmidt, Davisburg, MI (US)

(21) Appl. No.: 19/210,014

(22) Filed: May 16, 2025

Related U.S. Application Data
(60) Provisional application No. 63/649,663, filed on May 20, 2024.

(51) Int. Cl. B60C 25/13; B60C 25/05

(52) U.S. Cl. CPC B60C 25/13; B60C 25/0521; B60C 25/0539

(57) ABSTRACT

A system for disassembling a tire-wheel assembly includes a dismount stand, a robot, a first assembly, and a second assembly. The robot is disposed adjacent to the dismount stand. The first assembly is configured to detachably connect to the robot and engage the tire-wheel assembly. The first assembly and the robot are configured to retrieve the tire-wheel assembly from an initial location and position the tire-wheel assembly on the dismount stand. The second assembly is detachably coupled to the robot and is configured to disengage a tire of the tire-wheel assembly from a wheel of the tire-wheel assembly.

### CROSS-REFERENCE TO RELATED APPLICATIONS

This application claims the benefit of U.S. Provisional Application No. 63/649,663 filed May 20, 2024, the entire disclosure of which is incorporated by reference.

### FIELD

The present disclosure relates to a system for disassembling tire-wheel assemblies.

### BACKGROUND

Conventional systems for disassembling tire-wheel assemblies typically involve specialized equipment and manual labor. The specialized equipment may have limited versatility and may not be suitable for disassembling certain types of tire-wheel assemblies. Manual labor for dissembling tire-wheel assemblies can be time consuming and physically demanding, which may lead to inefficiencies and worker fatigue or injury. While known systems for dissembling tire-wheel assemblies have proven acceptable for their intended purpose, a continuous need for improvement remains in the art.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

One aspect of the disclosure provides a system for disassembling a tire-wheel assembly. The system includes a dismount stand, a robot, a first assembly, and a second assembly. The robot is disposed adjacent to the dismount stand. The first assembly is configured to detachably connect to the robot and engage the tire-wheel assembly. The first assembly and the robot are configured to retrieve the tire-wheel assembly from an initial location and position the tire-wheel assembly on the dismount stand. The second assembly is detachably coupled to the robot and is configured to disengage a tire of the tire-wheel assembly from a wheel of the tire-wheel assembly.

Another aspect of the disclosure provides an assembly. The assembly includes a base configured to detachably connect to an arm of a robot, a first plate connected to the base, a second plate connected to the base and spaced apart from the first plate, a first arm and a second arm connected to the first plate, a third arm and a fourth arm connected to the second plate, and a drawbar releasably connected to the base and disposed between the first plate and the second plate. In an assembled configuration, the first arm, the second arm, the third arm, and the fourth arm are configured to engage an outer portion of a tire or an outer portion of a wheel and the drawbar is configured to (i) separate from the base and (ii) detachably connect with the base to secure the wheel to the base.

Yet another aspect of the disclosure provides an assembly. The assembly includes a base configured to detachably connect to an arm of a robot, a first bead-breaker tool connected to the base, a second bead-breaker tool connected to the base, and a nozzle connected to the base and disposed between the first bead-breaker tool and the second bead-breaker tool. The assembly is configured to disengage, via the first bead-breaker tool and the second bead-breaker tool, a bead of a tire from a wheel while simultaneously spraying, via the nozzle, a lubricant on portions of the tire and the wheel.

An additional aspect of the disclosure provides a method for operating a system for disassembling a tire-wheel assembly. The method includes receiving a tire-wheel assembly from a first staging system. The method includes moving, via a first assembly and a robot, the tire-wheel assembly from the first staging system to a dismount stand. The method includes securing, via the first assembly and the robot, a wheel of the tire-wheel assembly to the dismount stand. The method includes disengaging, via a second assembly and the robot, a bead of a tire of the tire-wheel assembly from the wheel while simultaneously spraying, via the second assembly, a lubricant on portions of the tire and the wheel. The method includes separating, via the dismount stand, the tire from the wheel. The method includes moving, via the first assembly and the robot, the tire from the dismount stand to a second staging system. The method includes moving, via the first assembly and the robot, the wheel from the dismount stand to the second staging system or a third staging system.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a perspective view of an example system for disassembling tire-wheel assemblies in accordance with the principles of the present disclosure.

FIG. 2A is a perspective view of an example pick and place system of the system for disassembling tire-wheel assemblies in accordance with the principles of the present disclosure.

FIG. 2B is a perspective view of an example assembly for a pick and place system in accordance with the principles of the present disclosure.

FIG. 2C is a cross-sectional view of the assembly of FIG. 2B taken along the line 2C-2C of FIG. 2B.

FIGS. 3 and 4 are perspective views of operating the pick and place system in accordance with the principles of the present disclosure.

FIG. 5 is a perspective view of an example bead-breaker system of the system for disassembling tire-wheel assemblies in accordance with the principles of the present disclosure.

FIG. 6 is a schematic view of an example assembly of the bead-breaker system in accordance with the principles of the present disclosure.

FIG. 7 is a perspective view of an example dismount stand of the system for disassembling tire-wheel assemblies in accordance with the principles of the present disclosure.

FIG. 8 is a perspective view of operating the dismount stand in accordance with the principles of the present disclosure.

FIG. 9 is a perspective view of operating the pick and place system in accordance with the principles of the present disclosure.

FIG. 10 is a flowchart depicting an example method for operating the system for disassembling tire-wheel assembles in accordance with the principles of the present disclosure.

In the drawings, reference numbers may be reused to identify similar and/or identical elements.

### DETAILED DESCRIPTION

### Introduction

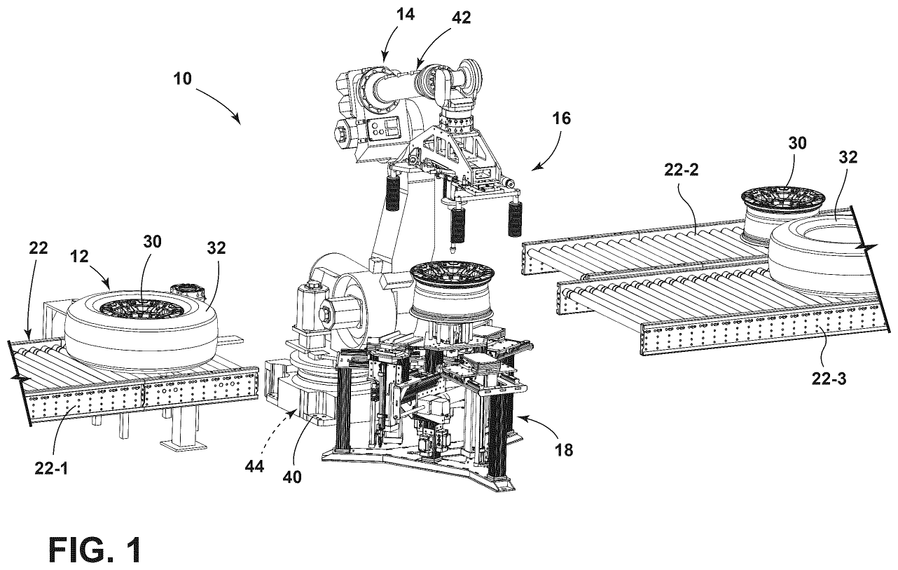

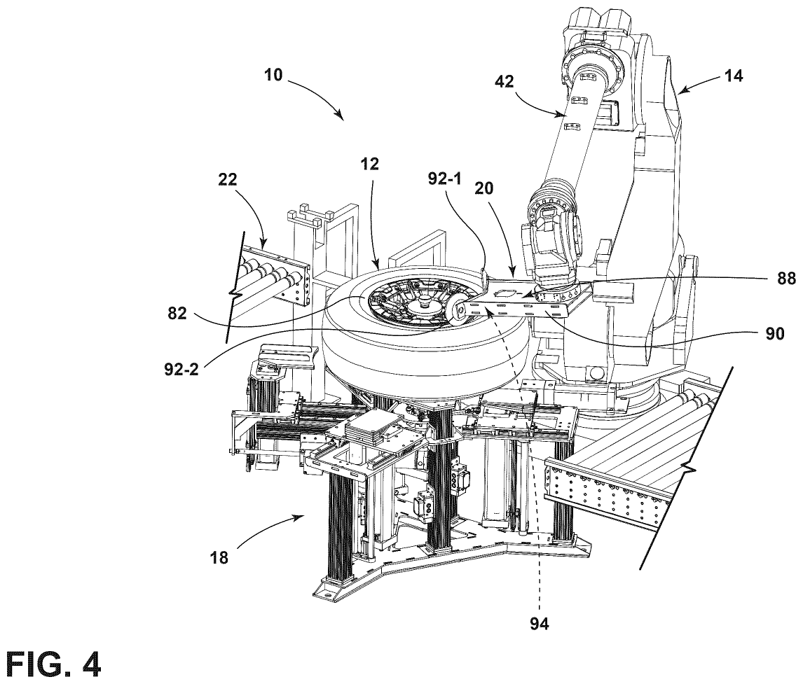

With reference to FIG. 1, an example system 10 for disassembling tire-wheel assemblies 12 is shown. As will be explained in more detail below, the system 10 may include at least one robot 14, a pick and place system 16, a dismount stand 18, a bead-breaker system 20 (FIG. 4), and/or at least one staging system 22 (e.g., a conveyor, a stand, a shelf, and/or a stage, etc.), among others. In various implementations, the robot 14 is disposed adjacent to the dismount stand 18. In some example configurations, at least portions of the pick and place system 16 and/or at least portions of the bead-breaker system 20 are connected to the robot 14. While the system 10 is generally depicted and described herein as including one robot 14, the system 10 may include more than one robot 14. For example, at least portions of the pick and place system 16 may be connected to a first robot and at least portions of the bead-breaker system 20 may be connected to a second robot.

In various implementations, a tire-wheel assembly 12 includes a wheel 30 and a tire 32. A wheel 30 and a tire 32 may comprise one or more of a variety of sizes, configurations, and/or materials. In an assembled configuration, the tire 32 is connected to (e.g., fixed) to the wheel 30.

In various implementations, the system 10 includes a first staging system 22-1 (e.g., a first conveyor), a second staging system 22-2 (e.g., a second conveyor), and/or a third staging system 22-3 (e.g., a third conveyor). In various implementations, the first staging system 22-1, the second staging system 22-2, and the third staging system 22-3 are disposed adjacent to the robot 14 and the dismount stand 18. While the system 10 is generally depicted and described herein as including three staging systems 22, the system 10 may include more or less than three staging systems 22.

In various implementations, the system 10 receives a tire-wheel assembly 12 from the first staging system 22-1. In various implementations, the pick and place system 16 moves the tire-wheel assembly 12 from the first staging system 22-1 to the dismount stand 18. The pick and place system 16 may secure a wheel 30 of the tire-wheel assembly 12 to the dismount stand 18. In various implementations, the bead-breaker system 20 disengages a tire 32 of the tire-wheel assembly 12 from the wheel 30.

In various implementations, the dismount stand 18 separates the tire 32 from the wheel 30. In various implementations, the pick and place system 16 moves the tire 32 from the dismount stand 18 to a staging system 22 (e.g., the third staging system 20-3). The pick and place system 16 may move the wheel 30 from the dismount stand 18 to a staging system 22 (e.g., the second staging system 22-2).

In various implementations, the system 10 disassembles various types and sizes of tire-wheel assemblies 12. The system 10 disassembles a large volume of tire-wheel assemblies 12 efficiently and quickly. For example, the system 10 may disassemble a tire-wheel assembly 12 in less than 1 minute. In various implementations, the system 10 operates semi-autonomously. Alternatively, the system 10 may operate autonomously without human intervention.

### Robot

With reference to FIG. 1, in various implementations, the robot 14 includes a base 40, at least one arm 42 at least indirectly connected to the base 40, and/or a controller 44, among others. In various implementations, the arm 42 moves in various directions (e.g., up, down, right, left, etc.) and rotates relative to the base 40. The arm 42 detachably connects with various components of the system 10 (e.g., portions of the pick and place system 16, portions of the bead-breaker system 20, pry bars, etc.). In various implementations, the controller 44 controls the movement of the arm 42, operation of components of the pick and place system 16, and/or components of the bead-breaker system 20, among others.

In various implementations, the controller 44 includes an electronic controller and/or an electronic processor, such as a programmable microprocessor and/or microcontroller. The controller 44 may include an application specific integrated circuit (ASIC). The controller 44 may include a central processing unit (CPU), a memory (for example, a non-transitory computer-readable storage medium), and/or an input/output (I/O) interface. The controller 44 may perform various functions, including those described in greater detail herein, with appropriate programming instructions and/or code embodied in software, hardware, and/or other medium. The controller 44 may include a plurality of controllers. The controller 44 may be connected to a display, such as a touch screen.

### Pick and Place System

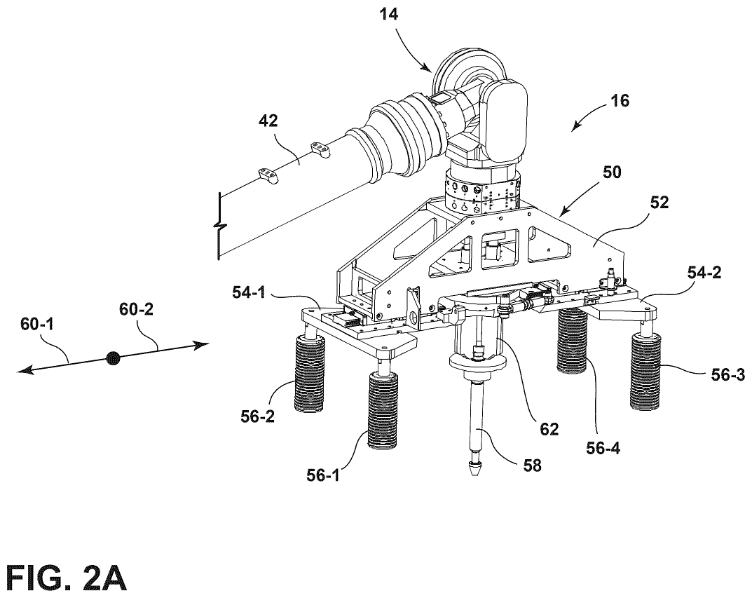

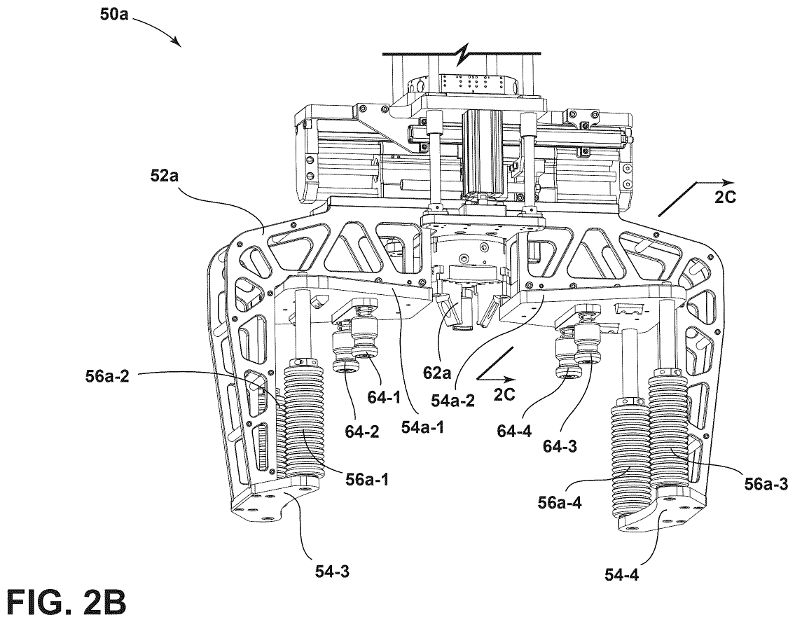

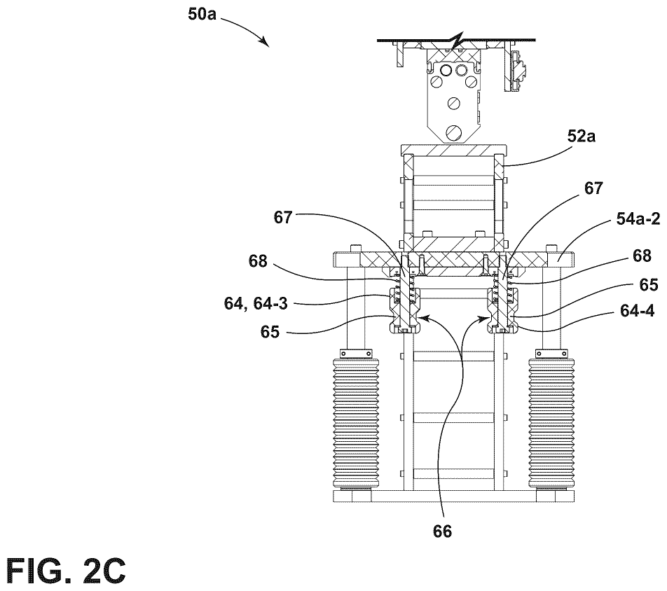

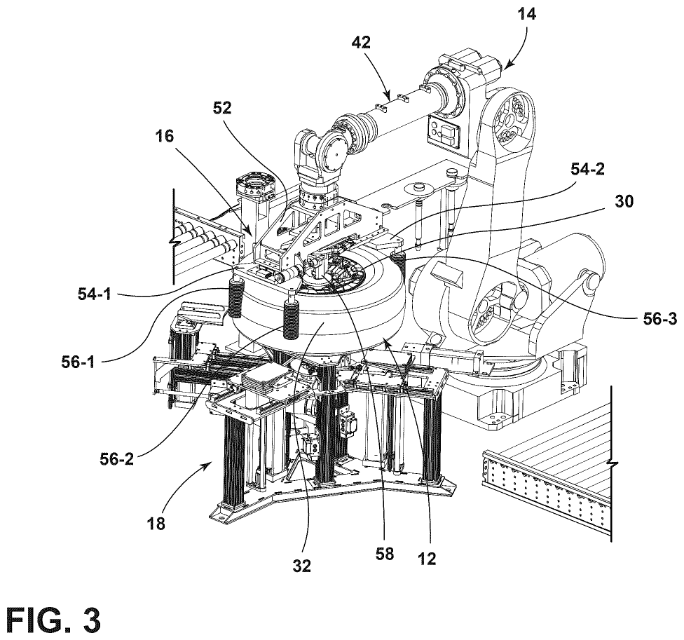

With reference to FIGS. 2A, 2B, 2C, and 3, an example pick and place system 16 is shown. In various implementations, the pick and place system 16 includes a robot 14 and/or an assembly 50, among others. In some example configurations, the assembly 50 is detachably connected to the robot 14. Referring now to FIG. 2A, in various implementations, the assembly 50 includes a base 52, a first plate 54-1, a second plate 54-2, a first arm 56-1, a second arm 56-2, a third arm 56-3, a fourth arm 56-4, and/or a drawbar 58, among others.

In various implementations, the base 52 is detachably connect to an arm 42 of a robot 14. In various implementations, the first plate 54-1 and the second plate 54-2 are slidably connected to the base 52. The first plate 54-1 and the second plate 54-2 may move in a first direction 60-1 relative to the base 52 and a second direction 60-2 opposite the first direction 60-1. In some examples, movement of the first plate 54-1 and the second plate 54-2 is controlled via the controller 44.

In various implementations, the first arm 56-1 and the second arm 56-2 are connected to the first plate 54-1. The third arm 56-3 and the fourth arm 56-4 may be connected to the second plate 54-2. In various implementations, the first arm 56-1, the second arm 56-2, the third arm 56-3, and the fourth arm 56-4 engage an outer portion of a tire 32 or an outer portion of a wheel 30 when the tire 32 and/or the wheel 30 is being moved via the assembly 50 and the robot 14. In various implementations, the controller 44 controls the movement of the first plate 54-1, the second plate 54-2, and the arms 56-1 to 56-4 to accommodate various sizes of wheels 30 and tires 32.

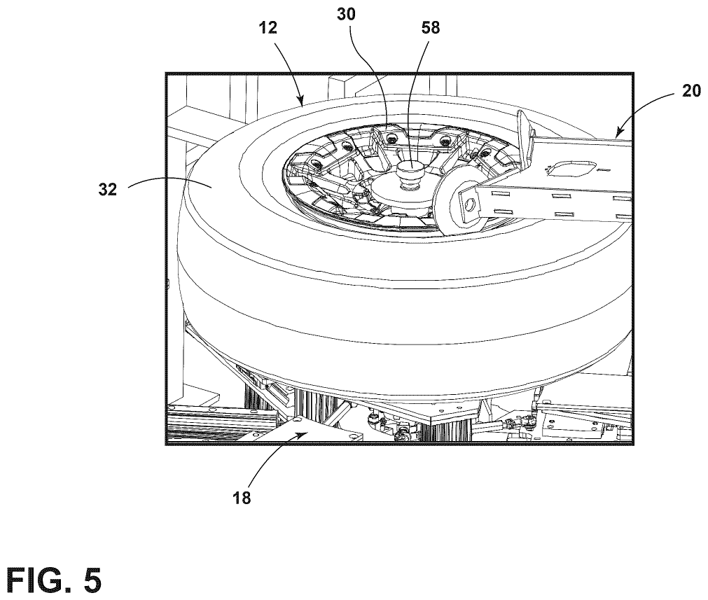

In various implementations, the drawbar 58 is releasably connected to the base 52. The drawbar 58 may be disposed between the first plate 54-1 and the second plate 54-2 in an assembled configuration. In various implementations, the drawbar 58 is released (e.g., separated) from the base 52 via a device 62 connected to the base 52 and controlled via the controller 44. With reference to FIG. 5, in various implementations, the drawbar 58 is released from the base 52 to secure a wheel 30 to the dismount stand 18. In various implementations, a portion of the drawbar 58 is received by an aperture in the dismount stand 18. The drawbar 58 may be removably connected to the dismount stand 18 to secure the wheel 30 to the dismount stand 18.

With reference to FIG. 2B, another assembly 50a for the pick and place system 16 is illustrated. In view of the similarity in structure and function of the assembly 50 to the assembly 50a, like reference numerals are used hereinafter and in the drawings to identify like components while like reference numerals containing letter extensions (e.g., “a”) are used to identify those components that have been modified.

In various implementations, the assembly 50a includes a base 52a, a first plate 54a-1, a second plate 54a-2, a third plate 54-3, a fourth plate 54-4, a first arm 56a-1, a second arm 56a-2, a third arm 56a-3, a fourth arm 56a-4, a drawbar 58 (not depicted), a first gripper 64-1, a second gripper 64-2, a third gripper 64-3, and/or a fourth gripper 64-4, among others. In various implementations, the first plate 54a-1, the second plate 54a-2, the third plate 54-3, and the fourth plate 54-4 may be connected to the base 52a.

In various implementations, the first arm 56a-1 and the second arm 56a-2 are connected to the first and third plates 54a-1, 54-3. The third arm 56a-3 and the fourth arm 56a-4 may be connected to the second and fourth plates 54a-2, 54-4. In various implementations, the first arm 56a-1, the second arm 56a-2, the third arm 56a-3, and the fourth arm 56a-4 engage an outer portion of a tire 32 when the tire-wheel assembly 12 or the tire 32 (e.g., without the wheel 30) is being moved via the assembly 50a and the robot 14.

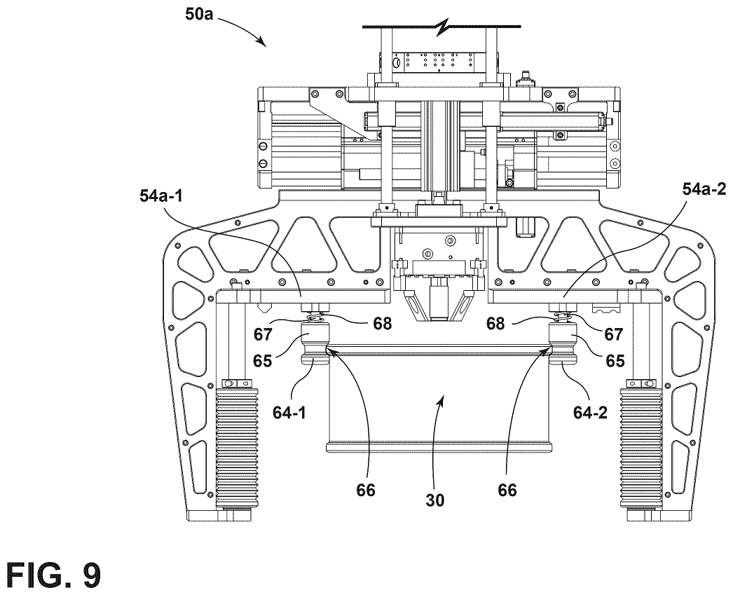

In various implementations, the first gripper 64-1 and the second gripper 64-2 are connected to the first plate 54a-1. The third gripper 64-3 and the fourth gripper 64-4 may be connected to the second plate 54a-2. Referring now to FIG. 9, the first gripper 64-1, the second gripper 64-2, the third gripper 64-3, and the fourth gripper 64-4 may engage an outer portion (e.g., a rim) of a wheel 30 when the wheel 30 is being moved via the assembly 50a and the robot 14. While the assembly 50a, is generally shown and depicted as including four grippers 64, the assembly 50a may include more or less than four grippers 64.

With reference to FIGS. 2C and 9, a gripper 64 (e.g., grippers 64-1 to 64-4) may include a body 65 defining a channel 66. The body 65 may define a cylindrical-shaped configuration. The channel 66 may receive a portion (e.g., a rim) of a wheel 30. The gripper 64 may include a rod 67 and a spring 68. The rod 67 may be connected to the body 65 and the first plate 54a-1 or the second plate 54a-2. The spring 68 may be connected to and/or disposed about the rod 67. The spring 68 may be disposed between a portion of the body 65 and the first plate 54a-1 or the second plate 54a-2. The body 65 may move (e.g., vertically and/or horizontally) relative to the first plate 54a-1 or the second plate 54a-2 to help facilitate the connection of the tire 30 to the assembly 50a.

In various implementations, the drawbar 58 is releasably connected to the base 52a. The drawbar 58 may be disposed between the first plate 54a-1 and the second plate 54a-2 in an assembled configuration. In various implementations, the drawbar 58 is released (e.g., separated) from the base 52a via a device 62a connected to the base 52a and controlled via the controller 44.

### Dismount Stand

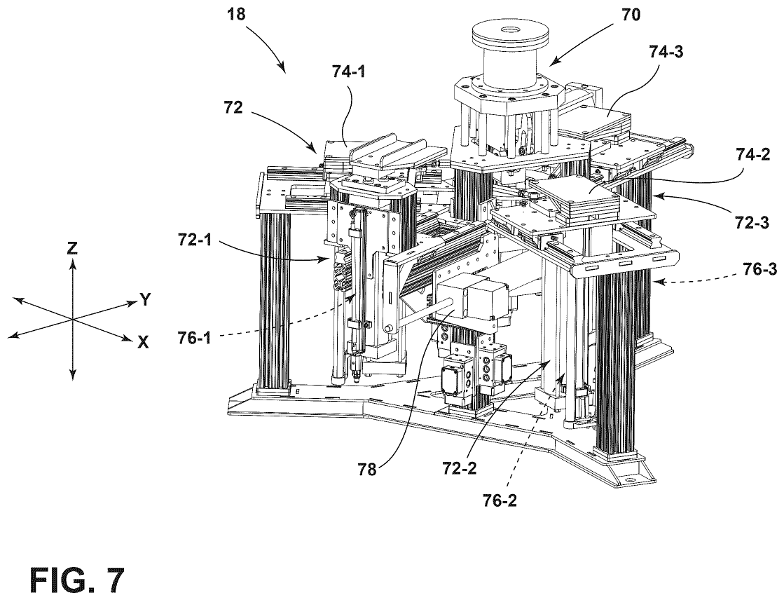

With reference to FIG. 7, an example dismount stand 18 is shown. In various implementations, the dismount stand 18 includes a central platform 70 and a set of modules 72 disposed about the central platform 70, among others. In various implementations, the central platform 70 supports and/or connects with a tire-wheel assembly 12. For example, a wheel 30 of the tire-wheel assembly 12 may be removably connected to the central platform 70. In various implementations, the central platform 70 connects with the drawbar 58. In some instances, the wheel 30 may be secured to the central platform 70 via the drawbar 58.

In various implementations, the set of modules 72 includes a first module 72-1, a second module 72-2, and/or a third module 72-3, among others. In various implementations, a portion (e.g., portions 74-1 to 74-3) of each module (e.g., modules 72-1 to 72-3) of the set of modules 72 engages a portion of a tire 32 and may move vertically (e.g., in Z-direction), via actuators 76-1 to 76-3 (e.g., actuator cylinders), to separate the tire 32 from a wheel 34.

In various implementations, the actuators 76-1 to 76-3 are controlled via a controller (e.g., controller 44, 78). In various implementations, the controller operates the actuators 76-1 to 76-3 sequentially to lift the tire 32 off of the wheel 30. For example, the first actuator 76-1 may be activated first, the second actuator 76-2 may be activated second, and the third actuator 76-3 may be activated third.

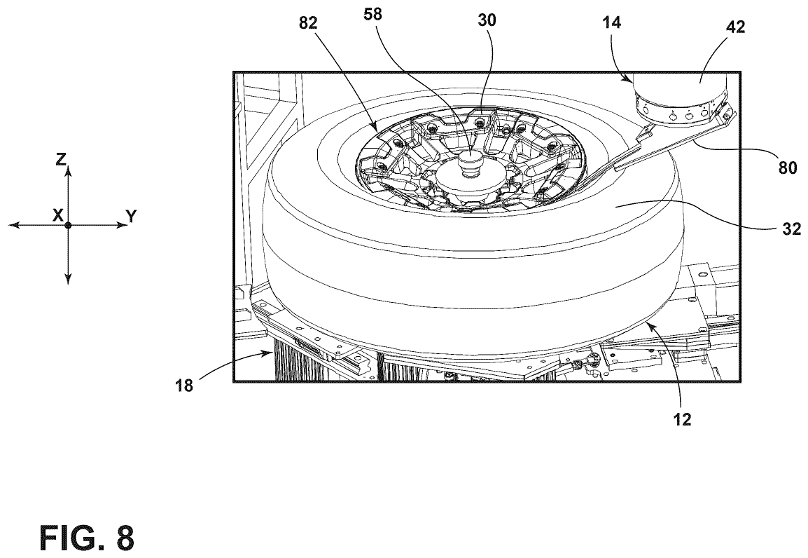

With reference to FIG. 8, in various implementations, a pry bar 80 is removably connected to an arm 42 of the robot 14 and lifts (e.g., in Z-direction) at least one bead 82 of a tire 32 to separate the bead 82 from the wheel 30 prior to and/or during operation of the actuators 76-1 to 76-3. While the dismount stand 18 is generally depicted and described herein as including three modules 72, the dismount stand 18 may include more or less than three modules 72.

### Bead-Breaker System

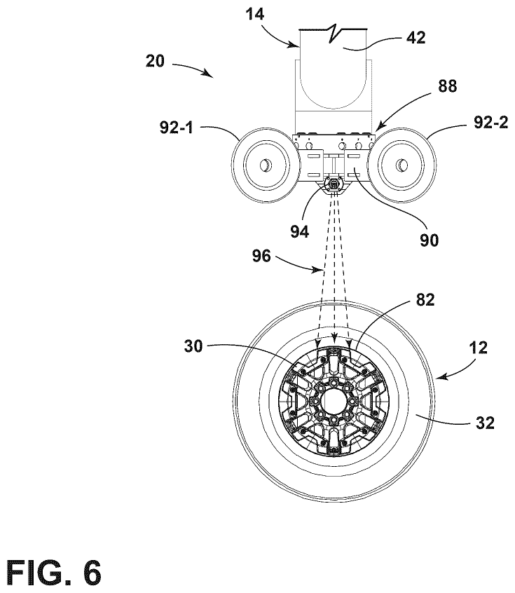

With reference to FIGS. 4-6, an example bead-breaker system 20 is shown. In various implementations, the bead-breaker system 20 includes a robot 14 and/or an assembly 88, among others. In some example configurations, the assembly 88 is detachably connected to the robot 14. In various implementations, the assembly 88 includes a base 90, a first bead-breaker tool 92-1 (e.g., a disc, a roller, etc.), a second bead-breaker tool 92-2 (e.g., a disc, a roller, etc.), and/or a nozzle 94, among others.

In various implementations, the base 90 is detachably connected to an arm 42 of a robot 14. In various implementations, the first bead-breaker tool 92-1, the second bead-breaker tool 92-2, and the nozzle 94 are connected to the base 90. In various implementations, the nozzle 94 is disposed between the first bead-breaker tool 92-1 and the second bead-breaker tool 92-2. In various implementations, the first bead-breaker tool 92-1 and the second bead-breaker tool 92-2 rotate relative to the base 90 during operation.

During operations of the bead-breaker system 20, the assembly 88 disengages, via the first bead-breaker tool 92-1 and the second bead-breaker tool 92-1, a bead 82 of a tire 32 from a wheel 30 while simultaneously spraying, via the nozzle 94, a lubricant 96 (e.g., a soap and water mixture, a silicone lubricant, a petroleum jelly, a rubber lubricant, a tire lubricant, among others) on portions of the tire 32 and the wheel 30. In some example configurations, the spraying of the lubricant 96 is controlled via a controller (e.g., controller 44). In various implementations, the lubricant 96 helps ease the separation of the tire 32 from the wheel 30 during operation of the system 10. While the assembly 88, is generally shown and depicted as including two bead-breaker tools 92 and one nozzle 94, the assembly 88 may include more or less than two bead-breaker tools 92 and may include more than one nozzle 94.

### Flowchart

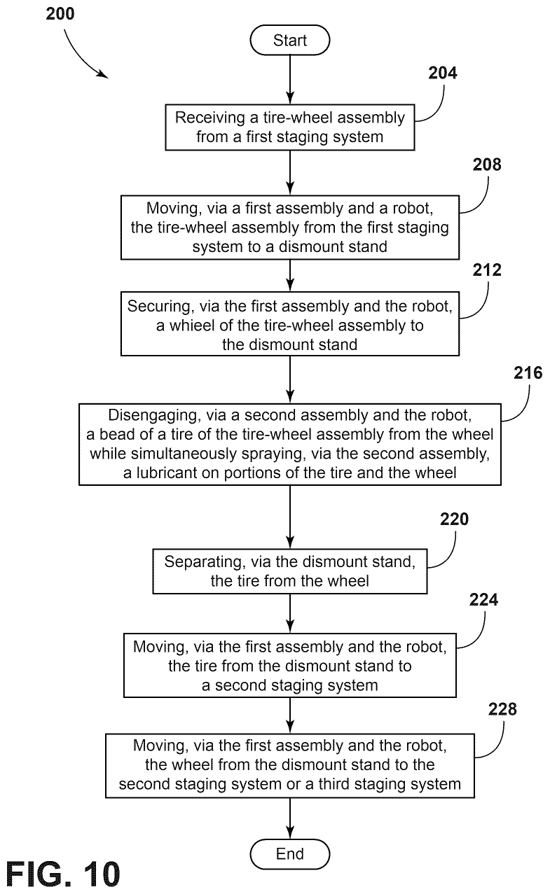

FIG. 10 is an example method 200 for operating a system 10 for disassembling a tire-wheel assembly 12. The method 200 may begin at 204. At 204, the system 10 may receive a tire-wheel assembly 12 from a first staging system 22-1. The method 200 may proceed to 208. At 208, a first assembly 50, 50a and a robot 14, may move the tire-wheel assembly 12 from the first staging system 22-1 to a dismount stand 18. The method 200 may proceed to 212.

At 212, the first assembly 50, 50a and the robot 14 may secure (e.g., via a drawbar 58) a wheel 30 of the tire-wheel assembly 12 to the dismount stand 18. The method may proceed to 216. At 216, a second assembly 88 and a robot 14 may disengage (e.g., via a first bead-breaker tool 92-1 and/or a second bead-breaker tool 92-2) a bead 82 of a tire 32 of the tire-wheel assembly 12 from the wheel 30 while simultaneously spraying, via a nozzle 94 of the second assembly 88, a lubricant 96 on portions of the tire 32 and the wheel 30. The method 200 may procced to 220.

At 220, the dismount stand 18 may separate (e.g., via a set of modules 72) the tire 32 from the wheel 30. In some examples, a pry bar 80, removably connected to the robot 14, may lift at least one bead 82 of the tire 32 off of the wheel 30 prior to and/or during operation of the dismount stand 18 to help facilitate separation of the tire 32 from the wheel 30. The method may proceed to 224.

At 224, the first assembly 50, 50a and the robot 14 may move the tire 32, separated from the wheel 30, from the dismount stand 18 to a second staging system 22-2. The method 220 may proceed to 228. At 228, the first assembly 50, 50a and the robot 14 may move the wheel 30 from the dismount stand 18 to the second staging system 22-2 or a third staging system 22-3. For example, the first, second, third, and/or fourth grippers 64-1 to 64-4 of the assembly 50a may engage the wheel 30 so that a portion (e.g., a rim) of the wheel 30 is disposed in the channels 66 of the grippers. The assembly 50a and the robot 14 may then move the wheel 30 to the second staging system 22-2 or the third staging system 22-3. Then the method 200 may end.

### CONCLUSION

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. In the written description and claims, one or more steps within a method may be executed in a different order (or concurrently) without altering the principles of the present disclosure. Similarly, one or more instructions stored in a non-transitory computer-readable medium may be executed in a different order (or concurrently) without altering the principles of the present disclosure. Unless indicated otherwise, numbering or other labeling of instructions or method steps is done for convenient reference, not to indicate a fixed order.

Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship encompasses a direct relationship where no other intervening elements are present between the first and second elements as well as an indirect relationship where one or more intervening elements are present between the first and second elements.

As noted below, the term “set” generally means a grouping of one or more elements. However, in various implementations a “set” may, in certain circumstances, be the empty set (in other words, the set has zero elements in those circumstances). As an example, a set of search results resulting from a query may, depending on the query, be the empty set. In contexts where it is not otherwise clear, the term “non-empty set” can be used to explicitly denote exclusion of the empty set—that is, a non-empty set will always have one or more elements.

A “subset” of a first set generally includes some of the elements of the first set. In various implementations, a subset of the first set is not necessarily a proper subset: in certain circumstances, the subset may be coextensive with (equal to) the first set (in other words, the subset may include the same elements as the first set). In contexts where it is not otherwise clear, the term “proper subset” can be used to explicitly denote that a subset of the first set must exclude at least one of the elements of the first set. Further, in various implementations, the term “subset” does not necessarily exclude the empty set. As an example, consider a set of candidates that was selected based on first criteria and a subset of the set of candidates that was selected based on second criteria; if no elements of the set of candidates met the second criteria, the subset may be the empty set. In contexts where it is not otherwise clear, the term “non-empty subset” can be used to explicitly denote exclusion of the empty set.

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” can be replaced with the term “controller” or the term “circuit.” In this application, the term “controller” can be replaced with the term “module.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); processor hardware (shared, dedicated, or group) that executes code; memory hardware (shared, dedicated, or group) that is coupled with the processor hardware and stores code executed by the processor hardware; other suitable hardware components that provide the described functionality; or a combination of some or all of the above, such as in a system-on-chip.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2020 (also known as the WIFI wireless networking standard) and IEEE Standard 802.3-2018 (also known as the ETHERNET wired networking standard). Examples of a WPAN are IEEE Standard 802.15.4 (including the ZIGBEE standard from the ZigBee Alliance) and, from the Bluetooth Special Interest Group (SIG), the BLUETOOTH wireless networking standard (including Core Specification versions 3.0, 4.0, 4.1, 4.2, 5.0, and 5.1 from the Bluetooth SIG).

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module. For example, the client module may include a native or web application executing on a client device and in network communication with the server module.

Some or all hardware features of a module may be defined using a language for hardware description, such as IEEE Standard 1364-2005 (commonly called “Verilog”) and IEEE Standard 1076-2008 (commonly called “VHDL”). The hardware description language may be used to manufacture and/or program a hardware circuit. In some implementations, some or all features of a module may be defined by a language, such as IEEE 1666-2005 (commonly called “SystemC”), that encompasses both code, as described below, and hardware description.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

The memory hardware may also store data together with or separate from the code. Shared memory hardware encompasses a single memory device that stores some or all code from multiple modules. One example of shared memory hardware may be level 1 cache on or near a microprocessor die, which may store code from multiple modules. Another example of shared memory hardware may be persistent storage, such as a solid state drive (SSD) or magnetic hard disk drive (HDD), which may store code from multiple modules. Group memory hardware encompasses a memory device that, in combination with other memory devices, stores some or all code from one or more modules. One example of group memory hardware is a storage area network (SAN), which may store code of a particular module across multiple physical devices. Another example of group memory hardware is random access memory of each of a set of servers that, in combination, store code of a particular module. The term memory hardware is a subset of the term computer-readable medium.

The apparatuses and methods described in this application may be partially or fully implemented by a special-purpose computer created by configuring a general-purpose computer to execute one or more particular functions embodied in computer programs. Such apparatuses and methods may be described as computerized or computer-implemented apparatuses and methods. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special-purpose computer, device drivers that interact with particular devices of the special-purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

The term non-transitory computer-readable medium does not encompass transitory electrical or electromagnetic signals propagating through a medium (such as on a carrier wave). Non-limiting examples of a non-transitory computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The term “set” generally means a grouping of one or more elements. The elements of a set do not necessarily need to have any characteristics in common or otherwise belong together. The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR.

Various example embodiments of the invention are described in the following clauses.

Clause 1: A system for disassembling a tire-wheel assembly, the system comprising: a dismount stand; a robot disposed adjacent to the dismount stand; a first assembly configured to detachably connect to the robot and engage the tire-wheel assembly, the first assembly and the robot configured to retrieve the tire-wheel assembly from an initial location and position the tire-wheel assembly on the dismount stand; and a second assembly detachably coupled to the robot and configured to disengage a tire of the tire-wheel assembly from a wheel of the tire-wheel assembly.

Clause 2: The system of clause 1, wherein: the dismount stand includes a central platform and a set of modules disposed about the central platform, the central platform is configured to support the tire-wheel assembly, and a portion of each module of the set of modules is configured to move vertically, via an actuator, to separate the tire from the wheel.

Clause 3: The system of clause 2, wherein: each module of the set of modules includes an actuator, and the actuators are activated sequentially to separate the tire from the wheel.

Clause 4: The system of any of clauses 1 through 3, wherein the first assembly includes: a base configured to detachably connect to an arm of the robot; a first plate connected to the base; a second plate connected to the base and spaced apart from the first plate; a first arm and a second arm connected to the first plate; and a third arm and a fourth arm connected to the second plate, the first arm, the second arm, the third arm, and the fourth arm are configured to engage an outer portion of the tire or an outer portion of the wheel.

Clause 5: The system of clause 4, wherein the first and second plates are slidably connected to the base.

Clause 6: The system of clause 4, wherein: the first assembly includes at least one gripper, and the gripper is configured to engage the outer portion of the wheel.

Clause 7: The system of clause 6, wherein: the gripper includes a body defining a channel, and the channel is configured to receive the outer portion of the wheel.

Clause 8: The system of clause 6, wherein the gripper is configured to move relative to the first plate or the second plate to facilitate connection of the wheel to the first assembly.

Clause 9: The system of clause 4, wherein: the first assembly includes a drawbar, the drawbar is releasably connected to the base, the drawbar is disposed between the first plate and the second plate in an assembled configuration, and the drawbar is configured to (i) separate from the base and (ii) detachably connect with the dismount stand to secure the wheel to the dismount stand.

Clause 10: The system of any of clauses 1 through 9, wherein the second assembly includes: a base configured to detachably connect to an arm of the robot; a first bead-breaker tool connected to the base; and a second bead-breaker tool connected to the base.

Clause 11: The system of clause 10, wherein: the second assembly includes a nozzle connected to the base and disposed between the first bead-breaker tool and the second bead-breaker tool, and the second assembly is configured to disengage, via the first bead-breaker tool and the second bead-breaker tool, a bead of the tire from the wheel while simultaneously spraying, via the nozzle, a lubricant on portions of the tire and the wheel.

Clause 12: The system of any of clauses 1 through 11, further comprising a set of staging systems disposed about the dismount stand.

Clause 13: An assembly comprising: a base configured to detachably connect to an arm of a robot; a first plate connected to the base; a second plate connected to the base and spaced apart from the first plate; a first arm and a second arm connected to the first plate; a third arm and a fourth arm connected to the second plate; and a drawbar releasably connected to the base and disposed between the first plate and the second plate in an assembled configuration, wherein: the first arm, the second arm, the third arm, and the fourth arm are configured to engage an outer portion of a tire or an outer portion of a wheel, and the drawbar is configured to (i) separate from the base and (ii) detachably connect with the base to secure the wheel to the base.

Clause 14: The assembly of clause 13, wherein the first and second plates are slidably connected to the base.

Clause 15: The assembly of clause 13, further comprising at least one gripper coupled to the first plate or the second plate, wherein the gripper is configured to engage the outer portion of the wheel.

Clause 16: The assembly of clause 15, wherein: the gripper includes a body defining a channel, and the channel is configured to receive the outer portion of the wheel.

Clause 17: The assembly of clause 15, wherein the gripper is configured to move relative to the first plate or the second plate to facilitate connection of the wheel to the assembly.

Clause 18: An assembly comprising: a base configured to detachably connect to an arm of a robot; a first bead-breaker tool connected to the base; a second bead-breaker tool connected to the base; and a nozzle connected to the base and disposed between the first bead-breaker tool and the second bead-breaker tool, wherein the assembly is configured to disengage, via the first bead-breaker tool and the second bead-breaker tool, a bead of a tire from a wheel while simultaneously spraying, via the nozzle, a lubricant on portions of the tire and the wheel.

Clause 19: The assembly of clause 18, wherein the first and second bead-breaker tools are configured to rotate relative to the base.

Clause 20: A method for operating a system for disassembling a tire-wheel assembly, the method comprising: receiving a tire-wheel assembly from a first staging system; moving, via a first assembly and a robot, the tire-wheel assembly from the first staging system to a dismount stand; securing, via the first assembly and the robot, a wheel of the tire-wheel assembly to the dismount stand; disengaging, via a second assembly and the robot, a bead of a tire of the tire-wheel assembly from the wheel while simultaneously spraying, via the second assembly, a lubricant on portions of the tire and the wheel; separating, via the dismount stand, the tire from the wheel; moving, via the first assembly and the robot, the tire from the dismount stand to a second staging system; and moving, via the first assembly and the robot, the wheel from the dismount stand to the second staging system or a third staging system.

1. A system for disassembling a tire-wheel assembly, the system comprising:
a dismount stand;
a robot disposed adjacent to the dismount stand;
a first assembly configured to detachably connect to the robot and engage the tire-wheel assembly, the first assembly and the robot configured to retrieve the tire-wheel assembly from an initial location and position the tire-wheel assembly on the dismount stand; and
a second assembly detachably coupled to the robot and configured to disengage a tire of the tire-wheel assembly from a wheel of the tire-wheel assembly.

2. The system of claim 1 wherein:
the dismount stand includes a central platform and a set of modules disposed about the central platform,
the central platform is configured to support the tire-wheel assembly, and
a portion of each module of the set of modules is configured to move vertically, via an actuator, to separate the tire from the wheel.

3. The system of claim 2 wherein:
each module of the set of modules includes an actuator, and
the actuators are activated sequentially to separate the tire from the wheel.

4. The system of claim 1 wherein the first assembly includes:
a base configured to detachably connect to an arm of the robot;
a first plate connected to the base;
a second plate connected to the base and spaced apart from the first plate;
a first arm and a second arm connected to the first plate; and
a third arm and a fourth arm connected to the second plate, the first arm, the second arm, the third arm, and the fourth arm are configured to engage an outer portion of the tire or an outer portion of the wheel.

5. The system of claim 4 wherein the first and second plates are slidably connected to the base.

6. The system of claim 4 wherein:
the first assembly includes at least one gripper, and
the gripper is configured to engage the outer portion of the wheel.

7. The system of claim 6 wherein:
the gripper includes a body defining a channel, and
the channel is configured to receive the outer portion of the wheel.

8. The system of claim 6 wherein the gripper is configured to move relative to the first plate or the second plate to facilitate connection of the wheel to the first assembly.

9. The system of claim 4 wherein:
the first assembly includes a drawbar,
the drawbar is releasably connected to the base,
the drawbar is disposed between the first plate and the second plate in an assembled configuration, and
the drawbar is configured to (i) separate from the base and (ii) detachably connect with the dismount stand to secure the wheel to the dismount stand.

10. The system of claim 1 wherein the second assembly includes:
a base configured to detachably connect to an arm of the robot;
a first bead-breaker tool connected to the base; and
a second bead-breaker tool connected to the base.

11. The system of claim 10 wherein:
the second assembly includes a nozzle connected to the base and disposed between the first bead-breaker tool and the second bead-breaker tool, and
the second assembly is configured to disengage, via the first bead-breaker tool and the second bead-breaker tool, a bead of the tire from the wheel while simultaneously spraying, via the nozzle, a lubricant on portions of the tire and the wheel.

12. The system of claim 1 further comprising a set of staging systems disposed about the dismount stand.

13. An assembly comprising:
a base configured to detachably connect to an arm of a robot;
a first plate connected to the base;
a second plate connected to the base and spaced apart from the first plate;
a first arm and a second arm connected to the first plate;
a third arm and a fourth arm connected to the second plate; and
a drawbar releasably connected to the base and disposed between the first plate and the second plate in an assembled configuration, wherein:
the first arm, the second arm, the third arm, and the fourth arm are configured to engage an outer portion of a tire or an outer portion of a wheel, and
the drawbar is configured to (i) separate from the base and (ii) detachably connect with the base to secure the wheel to the base.

14. The assembly of claim 13 wherein the first and second plates are slidably connected to the base.

15. The assembly of claim 13 further comprising at least one gripper coupled to the first plate or the second plate,
wherein the gripper is configured to engage the outer portion of the wheel.

16. The assembly of claim 15 wherein:
the gripper includes a body defining a channel, and
the channel is configured to receive the outer portion of the wheel.

17. The assembly of claim 15 wherein the gripper is configured to move relative to the first plate or the second plate to facilitate connection of the wheel to the assembly.

18. An assembly comprising:
a base configured to detachably connect to an arm of a robot;
a first bead-breaker tool connected to the base;
a second bead-breaker tool connected to the base; and
a nozzle connected to the base and disposed between the first bead-breaker tool and the second bead-breaker tool,
wherein the assembly is configured to disengage, via the first bead-breaker tool and the second bead-breaker tool, a bead of a tire from a wheel while simultaneously spraying, via the nozzle, a lubricant on portions of the tire and the wheel.

19. The assembly of claim 18 wherein the first and second bead-breaker tools are configured to rotate relative to the base.

20. A method for operating a system for disassembling a tire-wheel assembly, the method comprising:
receiving a tire-wheel assembly from a first staging system;
moving, via a first assembly and a robot, the tire-wheel assembly from the first staging system to a dismount stand;
securing, via the first assembly and the robot, a wheel of the tire-wheel assembly to the dismount stand;
disengaging, via a second assembly and the robot, a bead of a tire of the tire-wheel assembly from the wheel while simultaneously spraying, via the second assembly, a lubricant on portions of the tire and the wheel;
separating, via the dismount stand, the tire from the wheel;
moving, via the first assembly and the robot, the tire from the dismount stand to a second staging system; and
moving, via the first assembly and the robot, the wheel from the dismount stand to the second staging system or a third staging system.
